(19) United States
(12) Patent Application Publication
(10) Pub. No.: US 2004/0245279 A1
(43) Pub. Date: Dec. 9, 2004

(54) System for dispensing an active ingredient using a dispensable tablet, dispensable tablet and container for holding such dispensable tablets

(76) Inventors: Tareasa L. Bradley, Inver Grove Heights, MN (US); Eddie D. Sowle, Woodbury, MN (US)

Correspondence Address: IPLM GROUP, P.A., POST OFFICE BOX 18455, MINNEAPOLIS, MN, 55418, US

(21) Appl. No.: 10/429,486

(22) Filed: May 5, 2003

(51) Int. Cl. B65H 3/00; B65G 59/00; G07F 11/16

(52) U.S. Cl. 221/266

(57) ABSTRACT

Dispensable tablet, container and system for dispensing an active ingredient for a warewashing machine using a unit dose of the active ingredient for an operation of a warewashing machine. A plurality of dispensable tablets each contains an amount of the active ingredient equal to the unit dose. A container holds the plurality of dispensable tablets, each of the dispensable tablets containing the active ingredient, N of the plurality of dispensable tablets collectively containing an amount of the active ingredient equaling the unit dose, where N is an integer greater than zero and not more than ten. A dispenser, adapted to receive the dispensable tablets from the container and to be operably coupled to the warewashing machine, dispenses N of the plurality of dispensable tablets for the operation of the warewashing machine. The system prevents moisture from the warewashing machine from affecting the plurality of dispensable tablets being held in the container.

### TECHNICAL FIELD

This invention relates to a system for dispensing an active ingredient using a dispensable tablet, the dispensable tablet and a container for holding such dispensable tablets.

### BACKGROUND

Automated machines are often used for cleaning dishes, utensils, kitchen items, pots and pans, etc. These automated machines, commonly called warewashing machines, are often used by commercial establishments such as restaurants. A typical warewashing machine may use an active ingredient found in a detergent, rinse aid or sanitizer.

For a sanitizer, an active ingredient, such as chlorine, may be supplied in powdered or solid block form. A warewashing machine presents an adverse environment for such powdered or solid active ingredients. Since the active ingredient must react and dissolve quickly in water used in the warewashing machine, the solid or powdered active ingredients should be formulated to easily dissolve. However, this desired ability to dissolve quickly when used is a liability while the solid or powdered active ingredient has not yet been dispensed. The very wet and high temperature environment of the warewashing machine can degrade the solid or powdered active ingredients. If such wet and/or high temperature environment should come into contact with the active ingredient before being dispensed into the warewashing machine deleterious effects may result.

A relatively large, e.g., 600 gram, solid block can be utilized with a flood-type dispenser. As the ingredient in the solid is needed, the dispenser floods the solid block for a specified period of time with water. As water floods the solid block, the solid block erodes providing an ingredient/water solution using a portion of the solid block that has been eroded. Some, perhaps much, of the solid block remains for use in subsequent cycles of the machine to which the dispenser operates. During subsequent cycles, the solid block may again be flooded with water and the process is repeated.

However, some problems exist with this arrangement. Because of variations in water temperature, more or less of the active ingredient, e.g., chlorine, can be eroded from the solid block. For example, a lower water temperature will erode less chlorine from the solid block in the predetermined period of time allotted. However, a higher water temperature will erode more chlorine from the solid block in the same predetermined period of time. Depending upon the water temperature, either too much or too little chlorine may be used to produce a desired sanitizing solution.

Other forms of active ingredient dispensers also exist in the warewashing machine environment.

Powdered detergent is typically individually manually metered or poured into the warewashing machine. This, however, results in the non-uniform dose of detergent for the warewashing machine which is highly variable based upon the person performing the manual dispensing operation. Further, it is possible that the user could come into contact with the active ingredient which could raise a safety issue.

Alternatively, a tablet of detergent may be manually placed into a warewashing machine. While placing a tablet of detergent into the warewashing machine does provide a uniform dose, this dispensing system also requires the user to handle a tablet in order to manually place the tablet into the warewashing machine.

Another technique for dispensing an ingredient is known in the industry as a blister pack. A blister pack, well known in the industry, consists of a plastic top, typically clear, formed with indentations with each indentation capable of holding an individual dose of tablet or tablets. A backing sheet is adhered over the plastic top to secure the tablets in the indentations. A user may then take the blister pack and, pushing on the plastic top at an indentation, push an individual tablet or tablets contained in an indentation through the backing sheet, perforating the backing sheet, and releasing the tablet or tablets. While this technique also provides for uniform dose, it also could allow the user to come in contact with the tablet being dispensed. Most importantly, dispensing of tablets with a blister pack is an intensely manual operation.

PCT International Publication Number WO 02/058528, Hindustan Lever Limited, Detergent Dispenser System, describes a removable cartridge for a detergent dispensing system for a dishwasher. A storage unit contains a plurality of cylindrical or spherical detergent tablets arranged in two or more rows with curved surfaces of adjacent tablets touching such that when the cartridge is upright that tablets will move under gravity towards the transfer station. The transfer station has an ejection means to eject a tablet from the transfer station through a transfer port to prevent ingress of moisture into the cartridge. The dispensing system of Hindustan recognizes the problem of moisture contamination. Hindustan attempts to have the dispensing mechanism handle all of the responsibility of preventing the moisture from contaminating the dispensing container. However, Hindustan does not solve the problem because even a little moisture or extreme humidity can then contaminate not only the tablet being dispensed but literally the whole cartridge (container) of tablets.

### SUMMARY OF THE INVENTION

In contrast, the present invention provides a dispensing system providing ease of dispensing, a consistent unit dose and with no need of the user to handle the active ingredient being dispensed.

The present invention provides a system for dispensing an active ingredient for a warewashing machine using a unit dose of the active ingredient for an operation of the warewashing machine. A plurality of dispensable tablets, each of the plurality of dispensable tablets has an exterior and contains an amount of the active ingredient equal to the unit dose. A container holds the plurality of dispensable tablets, each of the dispensable tablets containing the active ingredient, N of the plurality of dispensable tablets collectively containing an amount of the active ingredient equaling the unit dose, where N is an integer greater than zero and not more than ten. A dispenser, adapted to receive the dispensable tablets from the container and to be operably coupled to the warewashing machine, dispenses N of the plurality of dispensable tablets for the operation of the warewashing machine. The system prevents moisture from the warewashing machine from affecting the plurality of dispensable tablets being held in the container.

In a preferred embodiment, N is one.

In an alternative embodiment, N is greater than one.

In an alternative embodiment, the present invention provides a dispensable tablet, adapted for use in a dispensing system for dispensing an active ingredient for a warewashing machine operable in a plurality of operations, each of the operations of the warewashing machine using a unit dose of the active ingredient. An amount of the active ingredient has an exterior formed into a rounded shape, the amount being equal to the unit dose. A protective coating covers at least a portion of the exterior of the amount of the active ingredient, the protective coating capable of protecting the dispensable tablet while the dispensable tablet is being dispensed, the protective coating dissolving during one of the plurality of operations of the warewashing machine.

In another alternative embodiment, the present invention provides a container of dispensable tablets adapted to be used in a warewashing machine operable in a plurality of operations, each of the plurality of operations of the warewashing machine using a unit dose of an active ingredient. A plurality of dispensable tablets, each of the plurality of dispensable tablets consisting of the unit dose of the active ingredient, each of the dispensable tablets having an exterior formed into a rounded shape, are held in the container.

In an embodiment, each of the plurality of dispensable tablets has a protective coating covering at least a portion of the exterior capable of protecting the dispensable tablet while the dispensable tablet is being dispensed and capable of dissolving during one of the plurality of operations of the warewashing machine.

In an embodiment, each of the plurality of dispensable tablets has a rounded shape.

In an embodiment, wherein each of the plurality of dispensable tablets is spherical.

In an embodiment, the rounded shape is a disk.

In an embodiment, the active ingredient comprises a halogen source.

In an embodiment, the active ingredient is chlorine.

In an embodiment, the active ingredient is solid chlorine.

In an embodiment, the active ingredient is a detergent.

In an embodiment, the active ingredient is a rinse additive.

In an embodiment, the dispenser prevents heat from the warewashing machine from affecting the plurality of dispensable tablets being held in the container.

In an embodiment, the dispenser comprises a gum ball type dispenser.

In an embodiment, the protective coating comprises titanium dioxide.

### BRIEF DESCRIPTION OF THE DRAWING

FIG. 1 shows a preferred embodiment of a dispensable tablet in accordance with the present invention;

FIG. 2 shows an alternative embodiment of a dispensable tablet in accordance with the present invention;

FIG. 3 is a cross-sectional view of the dispensable tablet of FIG. 1;

FIG. 4 illustrates a container holding a plurality of dispensable tablets in accordance with an embodiment of the present invention;

FIG. 5 is a cross-sectional view of a dispenser in accordance with an embodiment of the present invention and adapted for use with both a dispensable tablet and a container of dispensable tablets in accordance with preferred aspects of the present invention; and

FIG. 6 illustrates the dispenser of FIG. 5 with dispensable tablets being dispensed from a container in accordance with preferred aspects of the present invention.

### DETAILED DESCRIPTION

The present invention uses granular chlorine in a commercial warewashing environment. The preferred ingredients are sodium dichloro-s-triazinetrione dihydrate or sodium dichloroisocyanurate dihydrate.

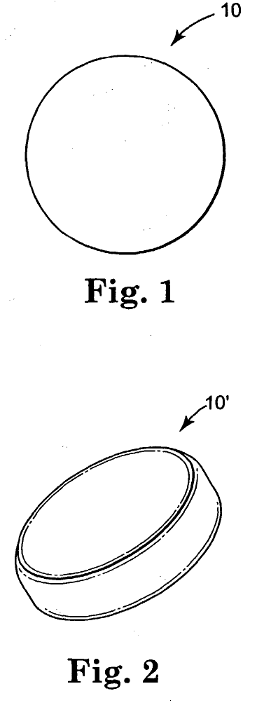

In a preferred embodiment, the active ingredient, in this example, chlorine, is contained in dispensable tablet 10, shown in cross-sectional view in FIG. 1. In order to avoid the problem of how much active ingredient to dispense into the warewashing machine, dispensable tablet 10 can be constructed to contain exactly the unit dose desired for optimum operation of the warewashing machine. Thus, when an operation of the warewashing machine needs an optimum dose of the active ingredient a single dispensable tablet 10 may be dispensed to the warewashing machine ensuring the proper dosage.

Alternatively, the unit dose desired for optimum operation of the warewashing machine can be contained in two or more of dispensable tablets 10 as long as an integral number of dispensable tablets 10 contain the intended dose for the warewashing machine. For example, if the intended dose for the warewashing machine is contained in two of dispensable tablets 10, then two dispensable tablets 10 can be dispensed when required. Of course, reasonableness is preferred in the number of dispensable tablets 10 the intended dose for the warewashing machine. As the number of dispensable tablets 10 over which the intended dose for the warewashing machine is spread, the more difficult it is to count the number of dispensable tablets 10 which must be dispensed and to actually dispense that number of dispensable tablets 10. For this reason, it is preferred that the number of dispensable tablets 10 over which the intended dose for the warewashing machine is spread be limited to not more than ten.

It is recognized that while it is preferred that a unit dose for the warewashing machine be contained in a single dispensable tablet 10, or in a plurality of dispensable tablets 10, that the warewashing machine could require differing amounts of the active ingredient during different cycles or with different options of single cycle. For example, the warewashing machine could require a single dispensable tablet 10 when operating in a normal mode and could require two or more dispensable tablets 10 when operating in a heavy duty mode. Nevertheless, at least one cycle of the warewashing machine in at least one mode operates with an intended dose of the active ingredient contained in a plurality of dispensable tablets 10, preferably not more than ten dispensable tablets 10.

Dispensable tablet 10 illustrated in FIG. 1 is spherical in shape. Other generally rounded shapes for dispensable tablet 10 are also contemplated. For example, dispensable tablet 10′ illustrated in FIG. 2 is of a generally disc shape, preferably with slightly rounded edges. This shape can also be compared to the common shape of medicinal tablet, such as an aspirin tablet. Dispensable tablet 10 and 10′ have generally rounded shapes in order that dispensable tablets 10 and 10′ may be more easily dispensed through automated dispensing equipment. It is also desirable that dispensable tablets 10 and 10′ have generally rounded shapes so that dispensable tablets 10 and 10′ do not have sharp corners, e.g., ninety degree three dimensional corners, which are subject to breakage as dispensable tablets 10 and 10′ are handled, both manually and with automated equipment but especially with automated equipment.

The preferred size for dispensable tablet 10′ is an approximately 0.7 gram tablet, plus or minus 0.5 grams, having a diameter of approximately 0.3750 inches (9.52 millimeters with a height of approximately 0.2205 inches (5.59 millimeters).

While dispensable tablet of the present invention may be any of a variety of shapes, two of the preferred shapes are illustrated in FIG. 1 as dispensable tablet 10 and in FIG. 2 as dispensable tablets 10′. It is to be recognized and understood that other shapes are possible. The remainder of the discussion in this disclosure will be made to dispensable tablet 10 but applies equally well to dispensable tablet 10′ and to a variety of shapes not specifically illustrated, for example elliptical shapes.

Since dispensable tablet 10 is a tablet, the active ingredient contained in dispensable tablet 10 is in solid form. In order that the active ingredient in dispensable tablet 10 can be utilized in the warewashing machine, dispensable tablet 10 should be readily dissolvable in the solution operatively utilized during operation of the warewashing machine. It is desirable that dispensable tablet 10 dissolve quickly in water so that the active ingredient can be effectively utilized by the warewashing machine. Dispensable tablet 10 should also be food contact safe.

However, since a warewashing machine often utilizes very hot water in order to accomplish its washing and/or sterilizing functions, the environment of the warewashing machine often contains very high humidities and, often, high temperatures. While this environment is conducive to effective washing and even to effective dissolving of dispensable tablet 10 once dispensed into the warewashing machine, such environment must be prevented from adversely affecting dispensable tablets 10 which have not yet been dispensed into the warewashing machine. As will be seen, part of the function of preventing moisture and, preferably, heat from affecting the supply of non-dispensed dispensable tablets 10 is accomplished in the dispensing apparatus. It is, however, also desirable that additional protection be taken to prevent the adverse effect of moisture and, preferably, heat on dispensable tablets 10 which have not yet been dispensed.

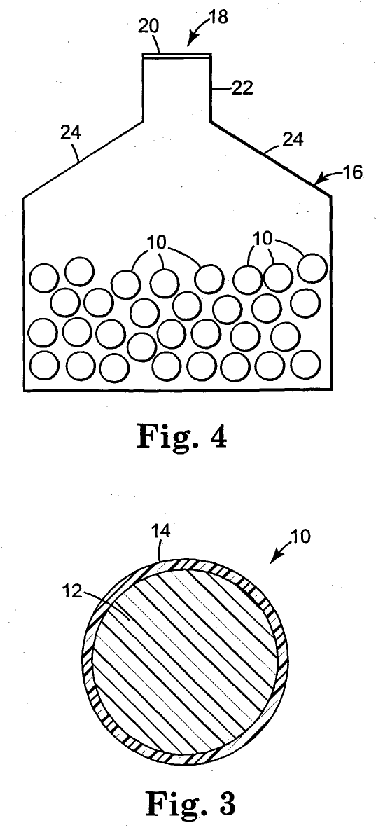

FIG. 3 is a cross-sectional view of dispensable tablet 10. The active ingredient is contained in the interior portion 12 of dispensable tablet 10. In a preferred embodiment, interior portion 12 of dispensable tablet 10 is a 0.7 gram spherical ball having a concentration of 70 parts per million consisting of fifty-six percent (56%) chlorine dry bleach for a tank size of the warewashing machine of approximately two (2) gallons (7.6 liters).

Other examples of active ingredients are pH modifiers, surfactants, enzymes, builders, lime away products, coupling agents, metal salts and components of rinse aids, detergents and sanitizers.

Dispensable tablet 10 also may have protective coating 14 surrounding the exterior of interior portion 12. Protective coating 14 can be made of a number of materials which can protect dispensable tablet from moisture, e.g., high humidity, and, preferably, heat when dispensable tablet is not yet dispensed. However, protective coating 14 can not be so protective that dispensable tablet 10 does not readily dissolve when dispensed into the warewashing machine. Protective coating 14 also protects dispensable tablet from mechanical breakage during shipping and dispensing. An example of a protective coating 14 is titanium dioxide coated from enzymes having an approximate thickness of the human hair, or approximately 0.1 millimeter. It is preferred that protecting be applied either by spraying or dipping.

It is also possible that interior portion 12 of dispensable tablet 10 could be in liquid or semi-liquid form with protective coating 14 forming a dissolvable shell around interior portion 12. This is similar to a paintball or bath beads in construction (although, obviously, paint is not utilized in a warewashing environment). In this embodiment, a liquid detergent or a liquid sanitizer could be used as the active ingredient. Once dispensed, again protective coating 14 would dissolve in the warewashing machine and the active ingredient contained in interior portion 12 would be released into the warewashing machine. Other examples of alternative forms of dispensable tablets 10 include gel tabs, a liquid or semi-liquid active ingredient contained in a water soluble film and a powder containing an active ingredient contained in a water soluble film. Other forms of packaging an active ingredient, e.g., a liquid or a powder, in a packet or other individualized container are also contemplated.

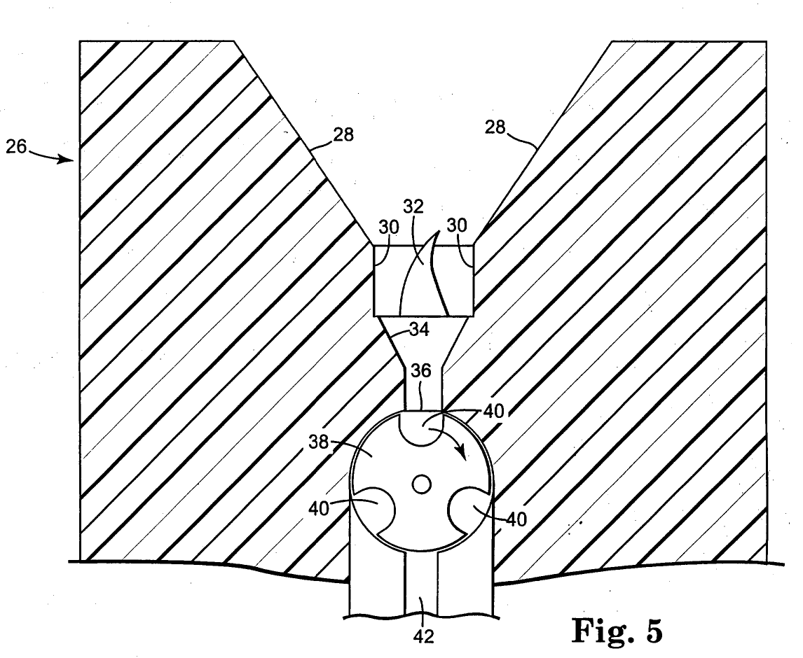

FIG. 4 illustrates container 16 holding a plurality of dispensable tablets 10. Container 16 has a relatively narrow opening 18, preferably sealed, for example with foil 20. With dispensable tablets 10 held in container 16, especially with foil 20 sealing opening 18, a user of the warewashing machine is protected from contacting dispensable tablets 10. Since the active ingredient contained in dispensable tablets 10 can be caustic to humans, preventing a user or another person coming into contact with container 16, e.g., a child, is desirable. Sealing container 16 with foil 20 also prevents an unskillful user from inadvertently coming into contact with dispensable tablets 10 as, for example, by simply unscrewing a screw-on lid. Container 16 has a relatively narrow neck 22 which allows container 16 to be inserted into a dispenser. Container 16 also has sloping side walls 24 which assist in enabling dispensable tablets 10 to flow toward opening 18 when container 16 is inverted and inserted into a dispenser.

FIG. 5 shows dispenser 26 adapted to dispense dispensable tablets 10 in accordance with a preferred aspect of the invention. Dispenser 26 has sloping walls 28 adapted to mate with sloping side walls 24 of container 16. Neck 22 of container 16 is accommodated. with a corresponding receptacle 30 in dispenser 26. Projection 32 is adapted to penetrate foil 20 seal of container 16 and release dispensable tablets 10 from container 16. Restriction section 34 funnels dispensable tablets 10 so that, at the lower end of restriction 34 only a single dispensable tablet 10 is allowed to pass at a time. Restriction 34 has an opening 36 adapted to mate with rotatable disc 38. Rotatable disc 38 rotates in a housing of dispenser 26 just slightly larger than rotatable disc 26. Rotatable disc 38 least one, and in this example, three, openings 40 sized to allow a single dispensable tablet 10 to fall from container 16 through restriction 34 into one of openings 40. A rotatable disc rotates a single dispensable tablet 10 accompanies each opening 40. As an opening 40 reaches the bottom of rotatable disc 40, a dispensable tablet 10 is released into passage 42 which is adapted to communicate with the warewashing machine into which dispensable tablet 10 is to be dispensed.

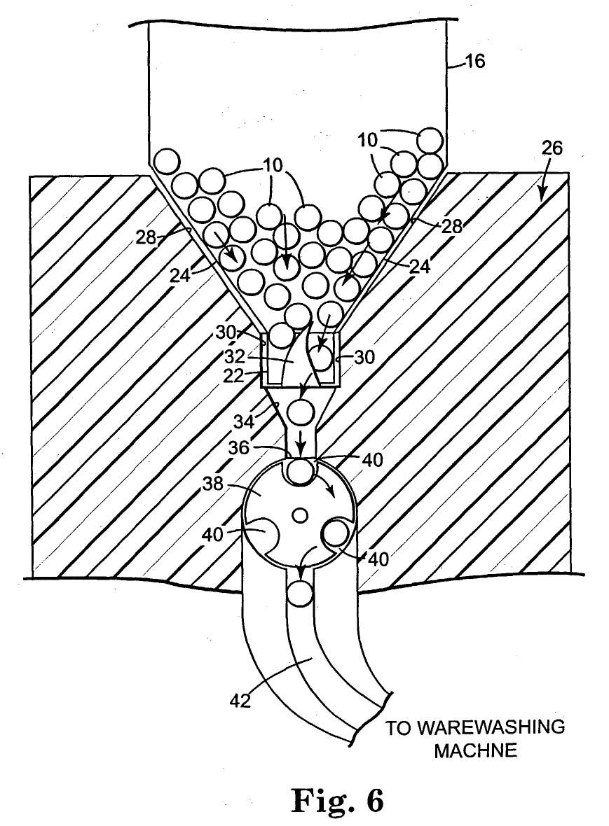

FIG. 6 shows container 16 having been inverted and inserted into dispenser 26. Dispenser 26 has mating sloping walls 28 to facilitate the insertion of and support of sloping side walls 24 of container 16. Neck 22 of container 16 is accommodated with a corresponding receptacle 30 in dispenser 26. As neck 22 of container 16 is inserted into receptacle 30 of dispenser 26, projection 32 penetrates foil 20 of container 16 puncturing foil 20 and releasing dispensable tablets 10 from container 16. Dispensable tablets 10 are funneled in restriction section 34 so that, at the lower end of restriction 34 only a single dispensable tablet 10 is allowed to pass at a time. Restriction 34 has an opening 36 adapted to mate with rotatable disc 38. Rotatable disc 38 in a housing of dispenser 26 just slightly larger than rotatable disc 26. Rotatable disc 38 least one, and in this example, three, openings 40 sized to allow a single dispensable tablet 10 to fall from container 16 through restriction 34 into one of openings 40. A rotatable disc rotates a single dispensable tablet 10 accompanies each opening 40. As an opening 40 reaches the bottom of rotatable disc 40, a dispensable tablet 10 is released into passage 42 which is adapted to communicate with the warewashing machine into which dispensable tablet 10 is to be dispensed.

Thus, as rotatable disc 38 is rotated so that the next opening 40 in rotatable disc reaches the bottom another dispensable tablet 10 is released into the warewashing machine through passage 42. Since dispensable tablets 10 still being held in container 16 are physically remote from passage 42, which may be contaminated with moisture from the warewashing machine, for example, and because any moisture laden air is prevented from directly being passed into container 16 by rotatable disc 38, dispenser 16 aids in preventing dispensable tablets 10 still being held in container 16 from being affected by the adverse high moisture content of the warewashing machine to which dispenser 26 is adapted to be utilized.

Of course, it is to be recognized and understood that if the intended dose for the warewashing machine calls for more than one dispensable ball 10, that rotatable discs is rotated through exactly the number of openings 40 for which the intended dose calls.

Rotatable disc 38 operated automatically through any number of commonly available and readily understood automated mechanical turning mechanisms. Alternatively, rotatable disc 38 may also be operated manually by the user.

It is to be recognized and understood that while the present invention has been described as or being used with a rotatable disc unit dispenser that other forms of unit dispensers could be used. Any form of generic unit dose dispenser, e.g., a cartridge dispenser, is also contemplated.

Various modifications and alterations of this invention will be apparent to those skilled in the art without departing from the scope and spirit of this invention. It should be understood that this invention is not limited to the illustrative embodiments set forth above.

What is claimed is:

1. A system for dispensing an active ingredient for a warewashing machine using a unit dose of said active ingredient for an operation of said warewashing machine, comprising:
a plurality of dispensable tablets, each of said plurality of dispensable tablets having an exterior and containing an amount of said active ingredient equal to said unit dose;
a container for holding said plurality of dispensable tablets, each of said dispensable tablets containing said active ingredient, N of said plurality of dispensable tablets collectively containing an amount of said active ingredient equaling said unit dose, where N is an integer greater than zero and not more than ten; and
a dispenser, adapted to receive said dispensable tablets from said container and to be operably coupled to said warewashing machine, for dispensing N of said plurality of dispensable tablets for said operation of said warewashing machine;
wherein said system substantially prevents moisture from said warewashing machine from affecting said plurality of dispensable tablets being held in said container.

2. A system for dispensing an active ingredient for a warewashing machine as in claim 1 wherein N is one.

3. A system for dispensing an active ingredient for a warewashing machine as in claim 1 wherein N is greater than one.

4. A system for dispensing an active ingredient for a warewashing machine as in claim 1 wherein each of said plurality of dispensable tablets has a protective coating covering at least a portion of said exterior, wherein said protective coating is capable of protecting said dispensable tablet while said dispensable tablet is being dispensed, and wherein said protective coating is capable of dissolving during one of said plurality of operations of said warewashing machine.

5. A system for dispensing an active ingredient for a warewashing machine as in claim 1 wherein each of said plurality of dispensable tablets has a rounded shape.

6. A system for dispensing an active ingredient for a warewashing machine as in claim 5 wherein each of said plurality of dispensable tablets is spherical.

7. A system for dispensing an active ingredient for a warewashing machine as in claim 1 wherein said active ingredient comprises a halogen source.

8. A system for dispensing an active ingredient for a warewashing machine as in claim 7 wherein said active ingredient is chlorine.

9. A system for dispensing an active ingredient for a warewashing machine as in claim 8 wherein said active ingredient is solid chlorine.

10. A system for dispensing an active ingredient for a warewashing machine as in claim 1 wherein said active ingredient is a detergent.

11. A system for dispensing an active ingredient for a warewashing machine as in claim 1 wherein said active ingredient is a rinse additive.

12. A system for dispensing a unit dose of an active ingredient for a warewashing machine as in claim 1 wherein said dispenser prevents heat from said warewashing machine from affecting said plurality of dispensable tablets being held in said container.

13. A system for dispensing a unit dose of an active ingredient for a warewashing machine as in claim 12 wherein said dispenser comprises a gum ball type dispenser.

14. A dispensable tablet, adapted for use in a dispensing system for dispensing an active ingredient for a warewashing machine operable in a plurality of operations, each of said operations of said warewashing machine using a unit dose of said active ingredient, comprising:
an amount of said active ingredient having an exterior formed into a rounded shape, said amount being equal to said unit dose; and
a protective coating covering at least a portion of said exterior of said amount of said active ingredient, said protective coating capable of protecting said dispensable tablet while said dispensable tablet is being dispensed, said protective coating dissolving during one of said plurality of operations of said warewashing machine.

15. A dispensable tablet as in claim 14 wherein said rounded shape is spherical.

16. A dispensable tablet as in claim 14 wherein said rounded shape is a disk.

17. A dispensable tablet as in claim 14 wherein said protective coating comprises titanium dioxide.

18. A dispensable tablet as in claim 14 wherein said active ingredient is chlorine.

19. A dispensable tablet as in claim 38 wherein said active ingredient is solid chlorine.

20. A dispensable tablet as in claim 14 wherein said active ingredient is a detergent.

21. A dispensable tablet as in claim 14 wherein said active ingredient is a rinse additive.

22. A container of dispensable tablets adapted to be used in a warewashing machine operable in a plurality of operations, each of said plurality of operations of said warewashing machine using a unit dose of an active ingredient, comprising:
a plurality of dispensable tablets, each of said plurality of dispensable tablets having an exterior formed into a rounded shape and containing an amount of said active ingredient equal to said unit dose; and
a container for holding said plurality of dispensable tablets.

23. A container as in claim 22 wherein each of said plurality of dispensable tablets has a protective coating covering at least a portion of said exterior, wherein said protective coating is capable of protecting said dispensable tablet while said dispensable tablet is being dispensed, and wherein said protective coating is capable of dissolving during one of said plurality of operations of said warewashing machine.

24. A container as in claim 22 wherein said rounded shape is spherical.

25. A container as in claim 22 wherein said rounded shape is a disk.

26. A container as in claim 22 wherein said active ingredient is chlorine.

27. A container as in claim 22 wherein said active ingredient is solid chlorine.

28. A container as in claim 22 wherein said active ingredient is a detergent.

29. A container as in claim 22 wherein said active ingredient is a rinse additive.
